(19) United States
(12) Patent Application Publication
(10) Pub. No.: US 2007/0070502 A1
(43) Pub. Date: Mar. 29, 2007

(54) Illuminating and imaging system comprising a diffractive beam splitter

(76) Inventors: Robert Brunner, Jena (DE); Hans-Jurgen Dobschal, Kleinromstedt (DE); Jorn Greif-Wustenbecker, Marburg (DE); Norbert Rosenkranz, Reichenbach (DE); Thomas Scherubl, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/554,332

(22) PCT Filed: Apr. 20, 2004
(86) PCT No.: PCT/EP04/04160

§ 371 Date: Sep. 19, 2006

(30) Foreign Application Priority Data
Apr. 25, 2003 (DE) 103 19 268.9

(51) Int. Cl. G02B 5/18; G02B 27/44

(52) U.S. Cl. 359/566

(57) ABSTRACT

The invention relates to an imaging system in which a diffractive optical element is used by both the illumination beam path and the imaging beam path. Said diffractive element operates in the reflection mode or transmission mode according to the specifications of the system design. At least one of the imaging optical elements provided in the beam path of the inventive diffractive beam splitter for imaging systems is used for both the illumination beam path and the imaging beam path. Said element represents a diffractive optical element (DOE) and requires no spatial separation between the imaging beam path and the illumination beam path in the object space by using different diffraction arrays. The number of reflective optical elements can be decreased by using diffractive optical elements, resulting in the cost of the system being reduced and the service life of the optical components being increased by using a low-power EUV source.

The invention relates to an imaging system in which a diffractive optical element is used by both the illumination beam path and the imaging beam path. Said diffractive element operates in the reflection mode or transmission mode according to the specifications of the system design.

The objective is to increase the resolution of the imaging system while fulfilling the telecentric condition.

The maximum resolution of an imaging system is primarily determined by the Numerical Aperture (NA) and the wave length (λ) used.

$$resolution ∼ \frac{wave length used}{Numerical Aperture}$$

The telecentric condition causes a constant magnification/reduction scale during defocusing, i.e. when viewing a three-dimensional object under a microscope whose lens fulfils the telecentric condition and displacing this object throughout the focus plane, the structure scale is not changed while different object areas are displayed sharp/focused and others unsharp/un-focused.

The basic principle of this invention can be applied in the complete range of electromagnetic radiation however proving particularly important in the wave length range below 100 nm. Above this level, systems can be set up using this invention both in the reflection mode and transmission mode. However, below 100 nm, the selection of transmitting “bulk” material is so low that the main mode of operation is the reflection mode. Said reflection range explicitly includes three large applications:
(A) lithography or stepper in the semiconductor industry at 13.5 nm
(B) material microscopy, i.e. mask inspection microscopy AIMS
(C) biologic specimen in the “water window”

Re A) For miniaturization of the microprocessor structures, reduction of the resolvable and imaginable structure sizes is required by the semiconductor industry. For this purpose, in the new steppers operating at 13.5 nm, the Numerical Aperture also is to be magnified. Assuming the resolution limit of a stepper used today operated at 157 nm with a NA=0.95, an EUV stepper (13.5 nm) requires a NA of 0.08, i.e., only from a NA greater than 0.08, a resolution advantage over today's 157 nm system is given. The Numerical Aperture of a modern two-element imaging system at 13.5 nm, i.e. a Schwarzschild design, is ˜0.1. This value was doubled due to our suggestion.

Re B) In material microscopy, both advantages of the invention are described exemplarily by means of mask inspection microscopy, the so-called Aerial Imaging Measurement (AIMS). The AIMS process basically simulates imaging of the stepper lithography mask. The lithography stepper images the mask structure is imaged reduced onto the holder to be exposed. In mask inspection, however, the structure is imaged magnified. During simulation, the Numerical Aperture (NA) of the microscope here usually is inversely proportional and adjusted with the magnification factor of the stepper. (Example: stepper aperture 0.4 with the stepper magnification factor 4=> Numerical Aperture of the simulation microscope 0.4/4=0.1) When viewing only one defect in the mask, magnification of the Numerical Aperture (NA) permits closer inspection without requiring an additional microscope. This option is available in the current devices purchasable to a very small extent only.

Mask inspection microscopes are used to define the stepper process window for a mask observing the image telecentry of the stepper for the defocusing area of the inspection microscope. The degree of displacement during defocusing not exceeding a certain structure width of the image is determined, i.e., the distance of the wafer from the projected image to be observed results from this. A more detailed description of functionality is given in the applications DE 10220816 and DE 10220815 (Engel et. al.)

Re C) The continuous reduction of the resolution limit is important not only to the semiconductor industry. For example, biologists and physicians take an interest in both the UVFI range and EUV microscopy in the so-called water window [2-5 nm (−500 eV)]. In this range, the water shows an absorption gap and thus has a higher transparency permitting biologic specimen to be examined in aqueous solution.

These incident-light imaging arrays operating in the reflection mode have in common that the illumination and imaging cone (Numerical Aperture NA) of the system is restricted geometrically. This problem is represented in FIG. I with the beam path of an imaging system which currently is prior art. The U.S. Pat. No. 5,144,497, U.S. Pat. No. 5,291,339 and U.S. Pat. No. 5,131,023 relate to X-ray microscopes using Schwarzschild systems as imaging systems. Amongst others, these have the disadvantage of involving a dark field imaging resulting in a distorted structure size.

Due to the geometrically determined incidence angle of the beam, the previous incident-light imaging arrays operating in the reflection mode do not fulfill the object telecentry condition conserving the imaging scale during defocusing and generating an image which is truer to the object.

Both the limitation of the Numerical Aperture and the geometrically determined incidence angle imply large restrictions for the imaging system. This can be avoided by using our invention. Up to now, the technology of diffractive elements has been used for spectral selection (spectral beam filtering) only by X-ray diffraction. In the U.S. Pat. No. 6,469,827 and U.S. Pat. No. 5,022,06, these diffractive elements are described for spectral split-up and selection of X-rays alone. In our case, however, we use the diffractive element, among others, for correcting and improving the imaging properties.

A number of techniques was used for magnifying the Numerical Aperture (NA) which works particularly well for the method suggested.
increasing the number of upstream or downstream optical elements. In the ETV energy range, each additional surface leads to a reduction in intensity of at least 30%.
using diffractive elements (DOE) instead of refractive or reflective elements (lenses, mirrors etc.).
using aspherical elements instead of spherical ones.
reducing the symmetry relative to the surfaces. An example will be described in more detail later on.

Each of the techniques stated can contribute to gradually increasing the NA.

The present invention is based on the assignment to develop a diffractive beam splitter for imaging systems avoiding the disadvantages known according to prior art. Also an improved resolution is supposed to be obtained by using high apertures.

According to the invention, the assignment is resolved due to the properties of the independent claims. Preferred further developments and designs are object of the claims related.

The invention is described exemplarily hereinafter using different design examples with representations given in

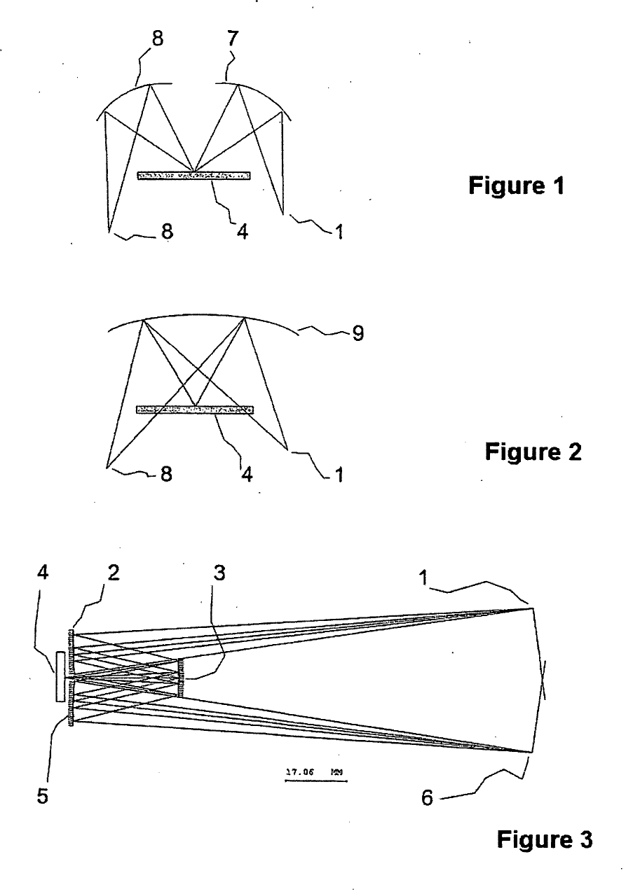

FIG. 1: the schematic beam trajectory in an incident-light imaging system comprising reflective components according to the prior art,

FIG. 2: the schematic beam trajectory of an incident-light imaging system modified according to the invention disclosure,

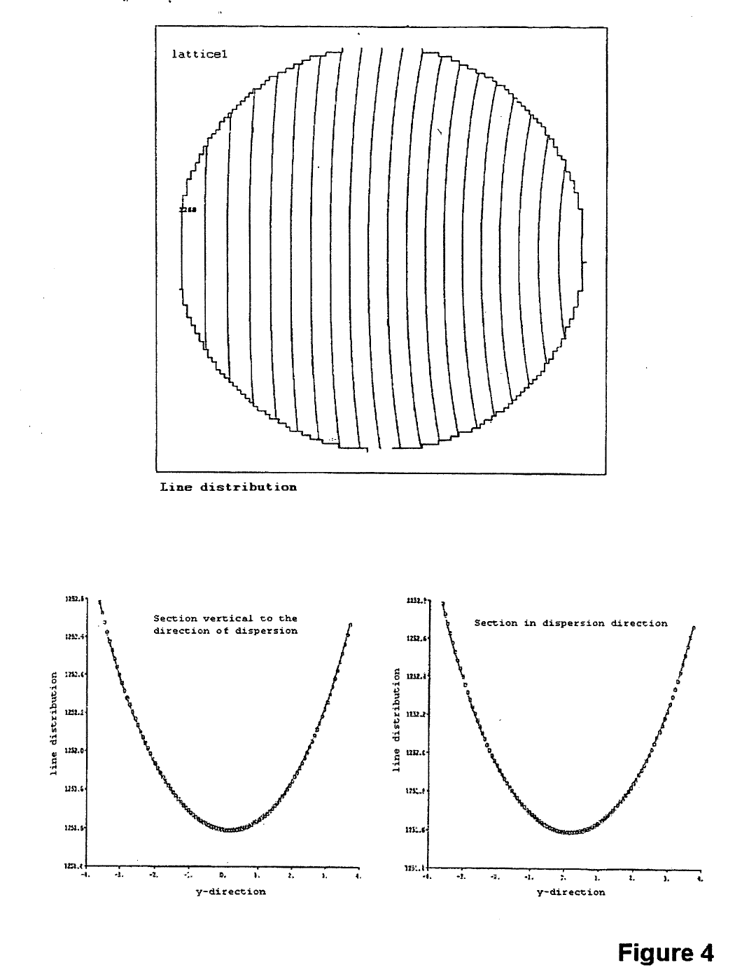

FIG. 3: an example of the beam trajectory in a reflection-incident-light imaging system according to the invention in symmetric design and

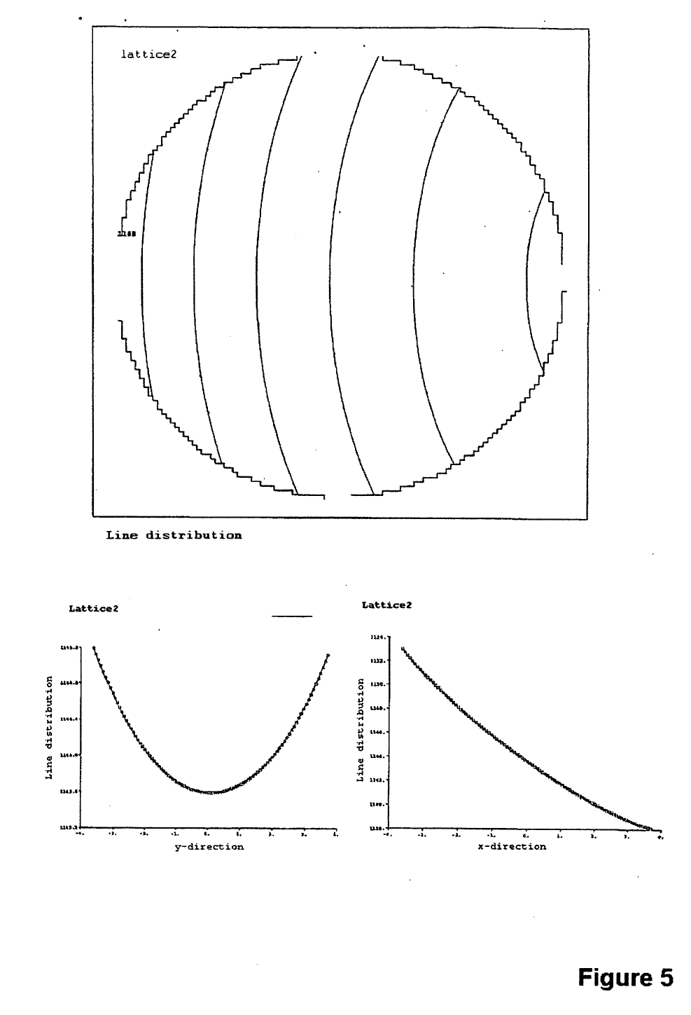

FIG. 4,5: a detailed description of the reflective-optical elements.

FIG. 1 shows the schematic beam trajectory in an imaging system according to prior art.

The radiation originated from the illumination source 1 is reflected by an imaging reflective element 7 onto the object 4. The beams reflected from there are imaged by a separate imaging optical element 8 into the intermediate focus plane 6. During this, the optical axes of the illumination and imaging beam path are separated from each other and inclined towards the normal of the object surface. In addition to the solid angles hereby restricted, the beveled incidence of radiation onto object 4 also has negative effects.

In contrast, FIG. 2 shows the schematic beam trajectory of the imaging system according to the invention. Due to the magnified solid angle (NA) for both illumination and imaging, a higher resolution is obtained. The telecentry condition for the image is fulfilled.

The radiation originated from a light source 1 passes from the imaging optical element 2 to an imaging optical element 3. The imaging optical element 3 shows a diffractive-reflective structure with imaging and beam-splitting properties. From the imaging optical element 3, at least a part of radiation is directed towards object 4 and provides illumination thereof. The radiation reflected by object 4 returns to the imaging optical element 3. A part of this radiation is used by the imaging optical element 3 for generating an image in the intermediate focus plane 6 passing the imaging optical element 5. The imaging optical element 3 with the diffractive-reflective structure is thus used for both the illumination beam path and the viewing beam path not requiring any spatial separation of the imaging and the illumination beam path in the object space by using different diffraction orders. The DOE which has an imaging effect can be situated straight in front of the object.

The diffractive-reflective structure is available on a spherical or planar base and shows a non-rotation symmetric asymmetric form. The spherical base can be concave or convex. The DOE shows a variable line number trajectory in at least one direction for improving the imaging properties. In addition, the telecentry condition for illumination and imaging is fulfilled.

In the diffractive beam splitter for imaging systems, further elements are situated in the imaging and viewing beam path upstream or downstream to the DOE. They contribute to compensation of the imaging properties of the diffractive optical element. These additional elements can be lenses, mirrors, DOEs or alike. The DOE here is used twice in the reflection mode. Also different numerical apertures can be set for the system.

In a different design, a number of application options can be adjusted by switching the illumination and imaging aperture. The profile shape of the DOE is symmetric in one plane in at least two mirror symmetry axes. The beam paths of the illumination and the image are symmetric to each other and the DOEs are used as complementary diffraction orders.

In a high-resolution imaging system according to the invention for a microscope based on extreme ultraviolet (EUV) radiation with wave lengths in the range of <100 nm and a magnification of 0.1-100× and a length below 5 m, at least one of the imaging optical elements 2, 3 and 4 available in the beam path shows a diffractive-reflective structure used both for the illumination beam path and the viewing beam path.

However, an imaging system comprising a non-symmetric illumination and imaging beam path is also feasible. In this way, the different requirements of both beam path lengths can be considered with more precision. The central element DOE 3 is described in more detail in FIG. 4. This is a reflective optical element with its diffractive structure situated on an imaging base. The diffractive structure shows a variable line number trajectory in x and y direction improving the imaging property of the complete system. The line number trajectories are by no means symmetric which becomes more obvious in FIG. 5.

The array according to the invention provides an imaging system avoiding the disadvantages known from prior art and ensuring a high imaging quality.

In EUV, the efficiency of the surface reflection drops rapidly with an increasing incidence angle limiting the realizable NA. The diffractive optical element reinforces the refraction power of the surfaces and leads to a higher realizable NA. Also the imaging system can be constructed more compactly.

The number of reflective optical elements can be decreased by using diffractive optical elements. Firstly, this results in reduced system costs and secondly, the life cycle of the optical components is increased by using a low-performance EUV source.

The microscopic examination of objects using x-rays, particularly with extremely ultraviolet (EUV) radiation, is gaining importance most notably in the semiconductor industry. Smaller structure sizes consequently require increasingly higher resolutions which can be obtained only by shortening the examination wave lengths. This is especially important during the microscopic inspection of masks for the lithography process.

X-ray microscopy is of particular importance in processes like i.e. the so-called AIMS (Aerial Imaging Measurement). In the AIM process, the lithography stepper is simulated using a more competitive and more simple microscopic array. It is essential to generate the image using the same wave length of approx. 13.5 nm, the same illumination conditions and the same image quality as in an EUV stepper. In contrast to the stepper, however, the image area of approx. 10 μm is far smaller than several mm. Another difference is that the mask typically is imaged 10-1,000 times magnified onto a camera.

1-14. (canceled)

15. A diffractive beam splitter for imaging systems imaging an object, the beam splitter comprising
an illumination beam path;
an imaging beam path;
an imaging optical element located in a common beam path where both the illumination beam path and the imaging beam path coincide;
said imaging optical element comprising a diffractive-optical element (DOE) which has different orders of diffraction whereby no spatial separation of the imaging and illumination optics in the common beam path is required.

16. A diffractive beam splitter for an imaging system according to claim 15 in which the DOE is situated directly in front of the object.

17. A diffractive beam splitter for imaging systems according to claim 15 in which the DOE has an imaging effect.

18. A diffractive beam splitter for imaging systems according to claim 15 in which said imaging optical element comprises a diffractive-reflective structure on a spherical, aspherical or planar base.

19. A diffractive beam splitter for imaging systems according to claim 15 in which the DOE has a concave or convex spherical base.

20. A diffractive beam splitter for imaging systems according to claim 15 with the DOE comprising a variable grating structure in at least one direction for improving the imaging properties.

21. A diffractive beam splitter for imaging systems according to claim 15, in which the diffractive beam splitter fulfills the telecentric condition for illumination and imaging.

22. A diffractive beam splitter for imaging systems according to claim 15, further comprising additional optical elements situated in the imaging and viewing beam path downstream or upstream from the DOE contributing to compensation of imaging properties of the diffractive optical element.

23. A diffractive beam splitter for imaging systems according to claim 22, in which the additional optical elements are selected from a group consisting of: lenses, mirrors and DOEs.

24. A diffractive beam splitter for imaging systems according to claim 15, wherein the DOE has a profile shape and the profile shape is substantially symmetrical in at least two mirror symmetry axes in one plane, and wherein the illumination beam path and the image beam path are substantially symmetrical to each other and the DOE includes complementary orders of diffraction.

25. A diffractive beam splitter for imaging systems according to claim 15 in which the DOE is utilized twice in the reflection mode.

26. A diffractive beam splitter for imaging systems according to claim 15 wherein the beam splitter is adjustable for different numerical apertures.

27. A diffractive beam splitter for imaging systems according to claim 15, further comrpsing an illumination aperture and an imaging aperture and wherein adjustment of different application options is made by switching the illumination and the imaging aperture.

28. A diffractive beam splitter for imaging systems according to claim 15, including an imaging optical system comprising a spherical concave base and a diffractive structure of not more than about 2,000 lines/mm used for both the illumination beam path and the imaging beam path.

29. An inspection system for lithography masks including an imaging system, the inspection system comprising:
a diffractive beam splitter;
an illumination beam path;
a viewing beam path;
an imaging optical element located in a common beam path where both the illumination beam path and the viewing beam path coincide;
in which the imaging optical element comprises a spherical concave base used both for the illumination beam path and the viewing beam path having a diffractive structure comprising not more than 2,000 lines/mm and further comprising an aperture and a diaphragm for adjusting the aperture.
